(19) United States
(12) Patent Application Publication
(10) Pub. No.: US 2008/0254771 A1
(43) Pub. Date: Oct. 16, 2008

(54) Apparatus and method for performing call setup for domain transfer in mobile communication system

(76) Inventors: Dong-Hee Lee, Yongin-si (KR); Hyung-Sop Song, Suwon-si (KR); Beom-Su Chung, Yongin-si (KR); Young-Yuk Kim, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 12/078,664

(22) Filed: Apr. 2, 2008

(30) Foreign Application Priority Data
Apr. 2, 2007 (KR) 10-2007-0032409

(51) Int. Cl. H04Q 7/22

(52) U.S. Cl. 455/412.2

(57) ABSTRACT

A mobile communication system and method for maintaining a call setup for a domain transfer are provided. The mobile communication system includes a calling terminal and a VCC server. The calling terminal notifies, when performing a domain transfer during reception of a ring-back tone in a call setup process with a called terminal, the domain transfer to the VCC server, and receives a response message for a call setup request from the VCC server to perform a call connection with the called terminal. The VCC server performs, when receiving a domain transfer notification message from the calling terminal, a call setup process with the domain to which the calling terminal transferred while maintaining the previous call setup process performed before the domain transfer, and releases the previous call setup process.

### PRIORITY

This application claims the benefit under 35 U.S.C. § 119 of a Korean Patent Application filed in the Korean Intellectual Property Office on Apr. 2, 2007 and assigned Serial No. 2007-32409, the disclosure of which is hereby incorporated herein by reference.

### BACKGROUND OF THE INVENTION

1. Field of the Invention

The present invention relates generally to a mobile communication system and method for performing call setup. More particularly, the present invention relates to an apparatus and method for performing call setup for domain transfer in a mobile communication system capable of providing an association between an IP multimedia subsystem (IMS) network and a circuit switch (CS) network.

2. Description of the Related Art

The evolution of communication technology has increased its ability to provide portable terminals with general voice services and high-rate data services that facilitate the operation of multimedia services such as e-mails, still pictures and moving pictures.

It is well known in the art that the third generation (3G) mobile communication systems support both general voice services and packet services. Examples of the 3G mobile communication systems include the synchronous CDMA 20001x system and the asynchronous UMTS (Universal Mobile Telecommunications System). The 3G mobile communication systems provide portable terminals with multimedia services through association between the IMS network and other networks.

The IMS network has been introduced as the release 5 standard in the 3GPP (3rd Generation Partnership Project).

The IMS network effectively supports multimedia services and wireless data demands, which are rapidly increasing, while supporting conventional voice services. The IMS network session initiation protocol (SIP) transmits control signals and messages between network components.

FIG. 1 is a diagram illustrating a scheme using an IMS network by a portable terminal 102.

Referring to FIG. 1, an IMS network includes a call session control function (CSCF) 110 for performing multimedia call processing and registration using an SIP protocol, and a home subscriber server (HSS) 112 for providing a combination of a home location register (HLR) function of a legacy mobile network and a function for mobility management and authentication of IP multimedia users.

The CSCF 110 performs different functions depending on the networks in use where subscribers are located. Thus, the CSCF 110 can be logically divided into a proxy-CSCF (P-CSCF), an interrogating CSCF (I-CSCF), and a serving CSCF (S-CSCF) depending on its location and function.

The P-CSCF is the first contact point of the portable terminal 102 in an IP multimedia network, and is present in the same domain as a gateway GPRS support node (GGSN). The P-CSCF receives an SIP registration request message from the portable terminal 102, transmits the SIP registration request message to the I-CSCF according to a home domain of the portable terminal 102, and transmits the SIP registration request message to the S-CSCF through a registration process by using a received S-CSCF address. The P-CSCF also performs an SIP message request/response function for the portable terminal 102.

The I-CSCF is the first contact point of the portable terminal 102 in the home network, where a plurality of domains may be present in one network.

The I-CSCF receives an address of an S-CSCF, which performs SIP registration of the portable terminal 120, from the HSS 112 to select the S-CSCF, or routes an SIP message received from other network to the S-CSCF.

The S-CSCF registers the fact that it is a session control server of the portable terminal 102 in the HSS 112, downloads/stores subscriber information of the portable terminal 102, and provides information related to service resources while managing the session state of the portable terminal 102.

The S-CSCF acquires an address of an I-CSCF of a home domain of a called portable terminal through an SIP URL or a dialed number of the portable terminal 102, and performs authentication using authentication information received from the HSS 112 for registration of the portable terminal 102. The S-CSCF may also function as the P-CSCF.

A media gateway controller (MGCF) 106 is located at the contact point between the IMS network and the PSTN to associate a voice call. The MBCF 106 manages and controls resources in an IMS-MGW 108.

The IMS-MGW 108 is a media gateway (MGW) used in the IMS network. For association with the PSTN, the IMS-MGW 108 converts IP packet media data into the format transmittable on a bearer of a circuit switch (CS) network.

As described above, the IMS network effectively supports multimedia services and wireless data demands, which are rapidly increasing, while supporting conventional voice services. The IMS network uses the SIP protocol to transmit control signals and messages between network components.

The mobile communication system supports a voice call continuity (VCC) function for continuing a voice call when the portable terminal 102 transfers from the IMS network to the CS network or from the CS network to the IMS network.

The VCC function includes a domain selection function that allows a called portable terminal to select a terminating domain among the CS network and the IMS network for a terminating call, and a domain transfer function that facilitates a seamless telephone call when the portable terminal transfers between the CS network and the IMS network.

However, the conventional VCC function is only available when a call setup between a calling portable terminal and a called portable terminal is completed.

For example, the VCC function is available when the portable terminal transfers between services networks after completing a call setup. However, the VCC function is unavailable if the call setup is not yet completed (for example, when a ring-back tone is received or when a phone bell is ringing), which causes the interruption of the call setup.

Accordingly, there is a need for an improved system and method for providing a VCC function that is available when a call setup has not been completed and prevents the interruption of the call setup.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide an apparatus and method for maintaining an ongoing call setup process when a domain transfer occurs during the ongoing call setup process in a mobile communication system.

Another object of an exemplary embodiment of the present invention is to provide an apparatus and method for maintaining a call setup process when a calling portable terminal receiving a ring-back tone transfers between domains in a mobile communication system.

Still another object of an exemplary embodiment of the present invention is to provide an apparatus and method for maintaining a call setup process when a called portable terminal ringing a phone bell transfers between domains in a mobile communication system.

According to one aspect of an exemplary embodiment of the present invention, a mobile communication system for maintaining a call setup for a domain transfer includes a calling terminal and a VCC server. The calling terminal notifies, when performing a domain transfer during reception of a ring-back tone in a call setup process with a called terminal, the domain transfer to the VCC server, and receives a response message for a call setup request from the VCC server to perform a call connection with the called terminal. The VCC server performs, when receiving a domain transfer notification message from the calling terminal, a call setup process with the domain to which the calling terminal transferred while maintaining the previous call setup process performed before the domain transfer, and releasing the previous call setup process.

According to another aspect of an exemplary embodiment of the present invention, a method for maintaining a call setup for a domain transfer of a calling terminal in a mobile communication system includes performing a call setup process. The calling terminal performs, when a domain transfer to a destination domain occurs during reception of a ring-back tone according to the call setup process, a call setup process to the destination domain to perform a call connection with a called terminal. AVCC server performs, when detecting a domain transfer of the calling terminal, a call setup process with the domain to which the calling terminal transferred while maintaining the previous call setup process performed before the domain transfer, and releasing the previous call setup process.

According to still another aspect of an exemplary embodiment of the present invention, a method for maintaining a call setup for a domain transfer of a called terminal in a mobile communication system includes notifying the domain transfer to a calling terminal and stopping a call setup process. The called terminal notifies, when a domain transfer to a destination domain occurs while a phone bell is ringing according to a call setup process, the domain transfer to a calling terminal. A VCC server stops, when detecting a domain transfer of the called terminal, the call setup process performed according to the domain transfer of the called terminal, and notifies the domain transfer of the called terminal to the calling terminal.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other exemplary objects, features and advantages of certain exemplary embodiments of the present invention will be more apparent from the following detailed description when taken in conjunction with the accompanying drawings in which:

FIG. 1 is a diagram illustrating a scheme for using an IMS network by a portable terminal;

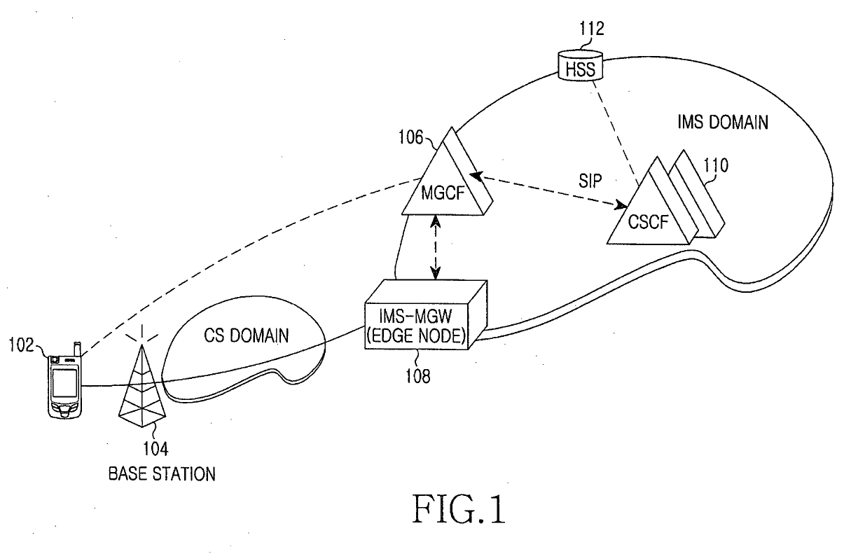

FIG. 2 is a block diagram of a mobile communication system facilitating a connection between a CS network and an IMS network according to an exemplary embodiment of the present invention;

FIG. 3 is a flow diagram illustrating a process for performing a call connection for a domain transfer of a calling portable terminal in a mobile communication system according to another exemplary embodiment of the present invention;

FIG. 4 is a flow diagram illustrating a process for performing a call connection at a VCC server in a mobile communication system for a domain transfer of a calling portable terminal according to another exemplary embodiment of the present invention;

FIG. 5 is a flow diagram illustrating a process for performing a call connection in a mobile communication system for a domain transfer of a calling portable terminal according to another exemplary embodiment of the present invention;

FIG. 6 is a flow diagram illustrating a process for performing a call connection for a domain transfer of a called portable terminal in a mobile communication system according to another exemplary embodiment of the present invention;

FIG. 7 is a flow diagram illustrating a process for performing a call connection at a VCC server in a mobile communication system for a domain transfer of a called portable terminal according to another exemplary embodiment of the present invention; and

FIG. 8 is a flow diagram illustrating a process for performing a call connection in a mobile communication system for a domain transfer of a called portable terminal according to another exemplary embodiment of the present invention.

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions are omitted for clarity and conciseness.

An exemplary embodiment of the present invention is intended to provide an apparatus and method for maintaining a call setup process when a portable terminal receiving a ring-back tone or a portable terminal ringing a phone bell transfers between domains in a mobile communication system capable of providing an association between an IMS network and a CS network.

In the following description, the portable terminal is a calling portable terminal receiving a ring-back tone or a called portable terminal ringing a phone bell.

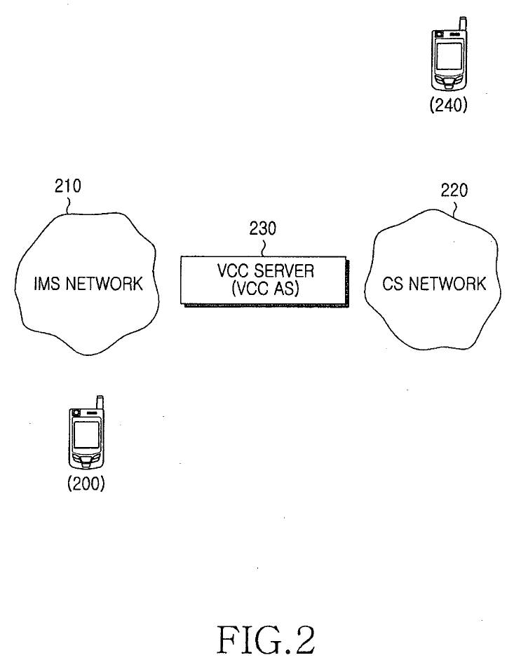

FIG. 2 is a block diagram of a mobile communication system that facilitates a connection between a CS network and an IMS network according to an exemplary embodiment of the present invention.

Referring to FIG. 2, the mobile communication system includes a calling portable terminal 200, an IMS network 210, a CS network 220, and a VCC server 230.

When the calling portable terminal 200 is located in the IMS network 210 and requests a call connection to a called portable terminal 240, a call connection is attempted with the called portable terminal 240 through the VCC server 230.

The calling portable terminal 200 then receives a ring-back tone and the called portable terminal 240 rings a phone bell. In this situation, when the calling portable terminal 200 receiving the ring-back tone transfers to the CS network 220, it performs a call setup process for the CS network 220.

When the calling portable terminal 200 performs the call setup process, the VCC server 230 notifies the transfer of the calling portable terminal 200 to the called portable terminal 240 through the IMS network 210 in which the calling portable terminal 200 was located before the domain transfer.

The VCC server 230 then receives a response message for a call setup request from the called portable terminal 240, transmits a response message for a call setup request to the calling portable terminal 200, and releases the previous call setup for the IMS network 210.

According to an exemplary implementation, the response message received by the VCC server 230 from the called portable terminal 240 is a response message for a call setup request, which is received from the IMS network 210 in which the calling portable terminal 200 was located before the domain transfer. The response message transmitted from the VCC server 230 to the calling portable terminal 200 is a response message for a call setup request, which is received from the CS network 220 to which the calling portable terminal 200 transferred.

Alternatively, when the called portable terminal 240 transfers from the IMS network 210 to the CS network 220 after ringing a phone bell, it performs a call setup process for the CS network 220 to perform domain registration and authentication.

The called portable terminal 240 then notifies the domain transfer to the VCC server 230. The VCC server 230, notified of the domain transfer of the called portable terminal 240, controls the called portable terminal 240 to stop the call setup process for the domain transfer to the CS network 220. The VCC server 230 then starts a call setup of the CS network 220 for the called portable terminal 240.

Once a hook-off event occurs in the called portable terminal 240, the called portable terminal 240 transmits a response message for the call setup of the calling portable terminal 200 to the VCC server 230. Then the VCC server 230 transmits a response message for the call setup request to the calling portable terminal 200.

According to an exemplary implementation, the response message received by the VCC server 230 from the called portable terminal 240 is a response message for a call setup request, which is received from the IMS network 210 in which the calling portable terminal 200 was located before the domain transfer. The response message transmitted from the VCC server 230 to the calling portable terminal 200 is a response message for a call setup request, which is received from the CS network 220 to which the calling portable terminal 200 transferred.

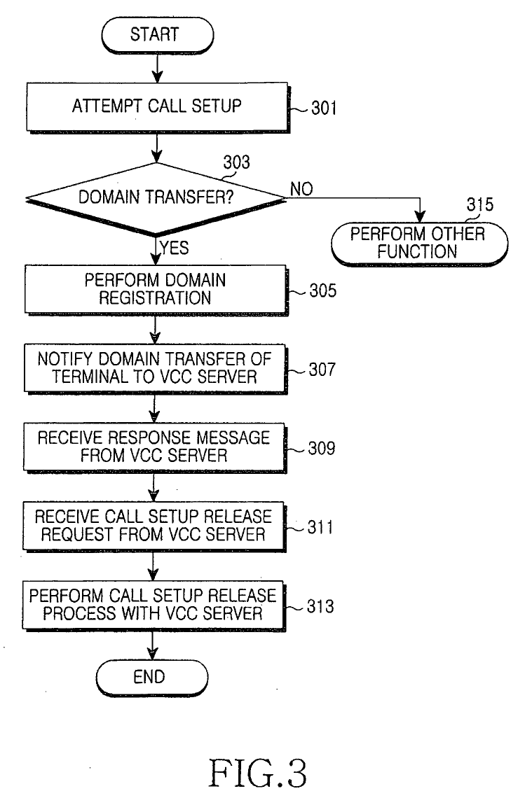

FIG. 3 is a flow diagram illustrating a process for performing a call connection for a domain transfer of the calling portable terminal 200 in the mobile communication system according to another exemplary embodiment of the present invention.

In step 301 of FIG. 3, the calling portable terminal 200 performs a call setup for a domain connectable from a specific region.

In step 303, the calling portable terminal 200 determines whether a domain transfer occurs.

According to an exemplary implementation, the domain transfer occurs when the calling portable terminal 200 capable of the association between the IMS network 210 and the CS network 220 receives a ring-back tone and transfers from the current service network, for which a call setup was performed, to another target service network.

For example, the calling portable terminal 200 transfers from the CS network 220 to the IMS network 210 or from the IMS network 210 to the CS network 220 during the domain transfer.

If the domain transfer does not occur (in step 303), the call connection process proceeds to step 315. In step 315, the calling portable terminal 200 performs another function (for example, a call setup for the current service network).

If the domain transfer occurs (in step 303), the call connection process proceeds to step 305. In step 305, the calling portable terminal 200 performs domain registration for a domain to which the calling portable terminal 200 is transferred (hereinafter referred to as a destination domain).

In this case, the domain registration of the calling portable terminal 200 registers in the destination domain, which may be performed using a conventional domain transfer process.

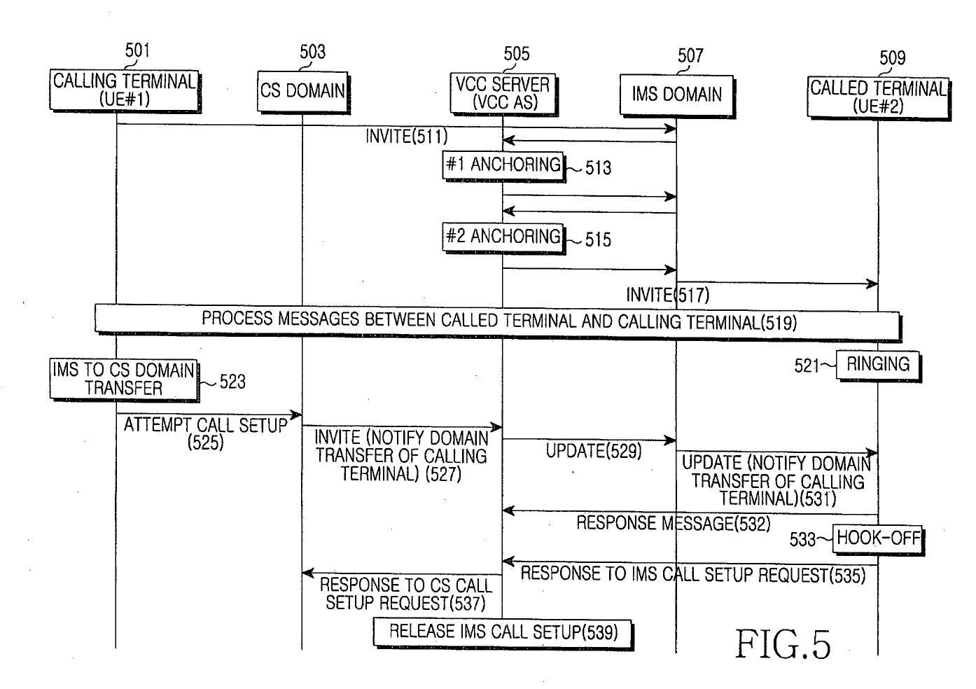

For example, the calling portable terminal 200 performs registration and authentication for the destination domain, routes a prescribed service code and a VCC service E. 164 number to a Voice Mail Service Center (VMSC), and gets the VMSC to transmit the prescribed service code to the VCC server 230. These processes will be described later in detail with reference to FIG. 5.

Although the domain transfer process has been described by prescribing the service code and the VCC service E. 164 number between the portable terminal and the VCC server, it may also be performed using the “3GPP2 X.P0042-001-0 9.2 Signaling Flow for Handoff: HRPD VoIP-to-1x Circuit-Switched Voice (Trigger Based) scheme”.

In step 307, the calling portable terminal 200 transmits a notification message for the domain transfer to the VCC server 230. In step 309, the calling portable terminal 200 receives a response message for a call setup request according to the hook off of the called portable terminal 240 from the VCC server 230.

In this case, the VCC server 230, which has received the domain transfer notification message in step 307, may transmit the received message to the called portable terminal 240 to notify the domain transfer of the calling portable terminal 200.

Also, the response message received from the VCC server 230 is a response message for a call setup request that is performed after the domain transfer of the calling portable terminal 200. The VCC server 230 receives a response message for a call setup request that is preformed before the domain transfer of the calling portable terminal 200 according to the hook-off state of the called portable terminal 240, and then transmits a response message for a call setup request, which is preformed after the domain transfer, to the calling portable terminal 200.

In step 311, the calling portable terminal 200 receives a call release request for a call setup process, which is preformed before the domain transfer, from the VCC server 230. In step 313, the calling portable terminal 200 performs a call release process with the VCC server 230.

In this case, the calling portable terminal 200 may perform the call release process with the VCC server 230 by using Cancel, 200 OK, 487, and ACK messages.

Thereafter, the call connection process is ended.

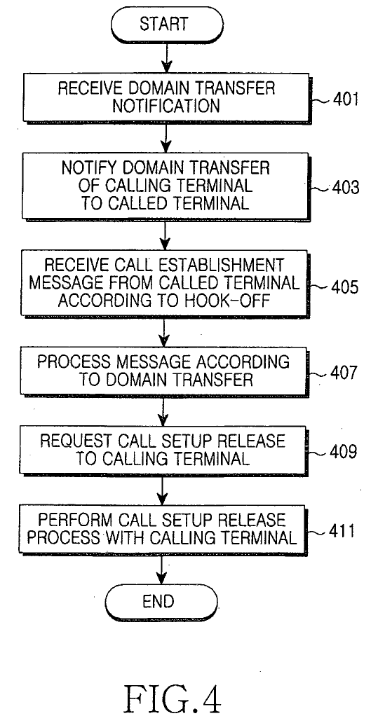

FIG. 4 is a flow diagram illustrating a process for performing a call connection at the VCC server 230 in the mobile communication system for a domain transfer of the calling portable terminal 200 according to another exemplary embodiment of the present invention.

Referring to FIG. 4, in step 401, the VCC server 230 receives domain transfer notification information from the calling portable terminal 200. In step 403, the VCC server 230 notifies the domain transfer of the calling portable terminal 200 to the called portable terminal 240.

According to an exemplary implementation, the domain transfer notification information for the calling portable terminal 200 may be detected by receiving an INVITE message of a call setup process performed in a domain to which the calling portable terminal 200 transferred. The VCC server 230 may transmit an UPDATE message to the called portable terminal 240 to notify the domain transfer of the calling portable terminal 200 to the called portable terminal 240.

For example, when the calling portable terminal 200 performs domain transfer, the VCC server 230 transmits information (for example, a media gateway IP address and a port) enabling communication with the calling portable terminal 200 to the called portable terminal 240 while maintaining the call setup process performed before the domain transfer.

In this case, the VCC server 230 receives a response message for the domain transfer of the calling portable terminal 200 from the called portable terminal 240 but does not transmit the received response message to the calling portable terminal 200.

In step 405, the VCC server 230 receives a call establishment notification message according to a hook-off event from the called portable terminal 240. In step 407, the VCC server 230 transmits a response message for a call setup process to the calling portable terminal 200, thereby processing a message according to the domain transfer.

According to an exemplary implementation, the response message transmitted from the VCC server 230 to the calling portable terminal 200 in step 407 is a response message (ANM 200 OK) for the call setup process performed after the domain transfer of the calling portable terminal 200.

In step 409, the VCC server 230 performs a call setup release request performed by the calling portable terminal 200. In step 411, the VCC server 230 performs a call setup release process performed by the calling portable terminal 200.

The call setup release request is a request for releasing the call setup process performed before the domain transfer of the calling portable terminal 200.

Thereafter, the call connection process is ended.

FIG. 5 is a flow diagram illustrating a process for performing a call connection in the mobile communication system for a domain transfer of a calling portable terminal according to another exemplary embodiment of the present invention.

Referring to FIG. 5, the mobile communication system includes a calling portable terminal 501, a CS network 503, a VCC server 505, an IMS network 507, and a called portable terminal 509.

First, the calling portable terminal 501 performs a call setup process 511 for performing a call connection with the called portable terminal 509 through the IMS network 507.

According to an exemplary implementation, the call setup process may be performed by first transmitting an INVITE message to the IMS network 507. The IMS network 507 transmits the received message to the VCC server 505, thereby performing an anchoring process 513 of the calling portable terminal 501.

The anchoring process 513 is a process for the VCC server 505 to store/manage user information and call information for the corresponding call request during a call setup process so that a portable terminal performing a domain transfer can maintain a stable call connection, and an anchoring process of the called portable terminal 509 is also performed.

Thereafter, the mobile communication system performs a message processing process 519 between the calling portable terminal 501 and the called portable terminal 509. the message processing process may be performed by transmitting an INVITE message to the called portable terminal 509 (in step 517).

In this case, the message processing process 519 is a process that is performed from the time when the calling portable terminal 501 receives a ring-back tone to the time when the called portable terminal 509 rings a phone bell. In the message processing process 519, the mobile communication system processes an INVITE message, a 183 session progress message, an UPDATE message, and a 180 ringing message.

When the message processing process 519 is completed, the called portable terminal 509 rings a phone bell (in step 521).

Once the calling portable terminal 501 transfers from the IMS network 507 to the CS network 503 (in step 523), the calling portable terminal 501 attempts a call setup process for the CS network 503 (in step 525).

The calling portable terminal 501 informs the VCC server 505 that the calling portable terminal 501 is performing a call setup process according to the domain transfer via an INVITE message (in step 527) through the CS network 503.

After detection of the domain transfer of the calling portable terminal 501, the VCC server 505 notifies the domain transfer of the calling portable terminal 501 to the called portable terminal 509 by means of an UPDATE message (in step 529) through the IMS network 507 (in step 531).

For example, when the calling portable terminal 501 performs domain transfer, the VCC server 505 transmits information (for example, a media gateway IP address and a port) to facilitate communication with the calling portable terminal 501 to the called portable terminal 509 while maintaining the call setup process performed before the domain transfer.

The called portable terminal 509 transmits a response message for the received information to the VCC server 505 (in step 532). In this case, the VCC server 505 waits a hook-off event of the called portable terminal 509 without transmitting the received response message to the calling portable terminal 501.

Thereafter, when a hook-off event occurs in the called portable terminal 509 (in step 533), the called portable terminal 509 transmits a response message for a call setup request generated by the IMS network 507 to the VCC server 505 (in step 535). Upon receipt of the response message from the called portable terminal 509, the VCC server 505 transmits a response message for a call setup request generated by the CS network 503 to the calling portable terminal 501 (in step 537).

The VCC server 505 then releases an IMS call setup performed before the domain transfer of the calling portable terminal 501 (in step 539).

The VCC server 505 may release the IMS call setup by using Cancel, 200 OK, 487, and ACK messages.

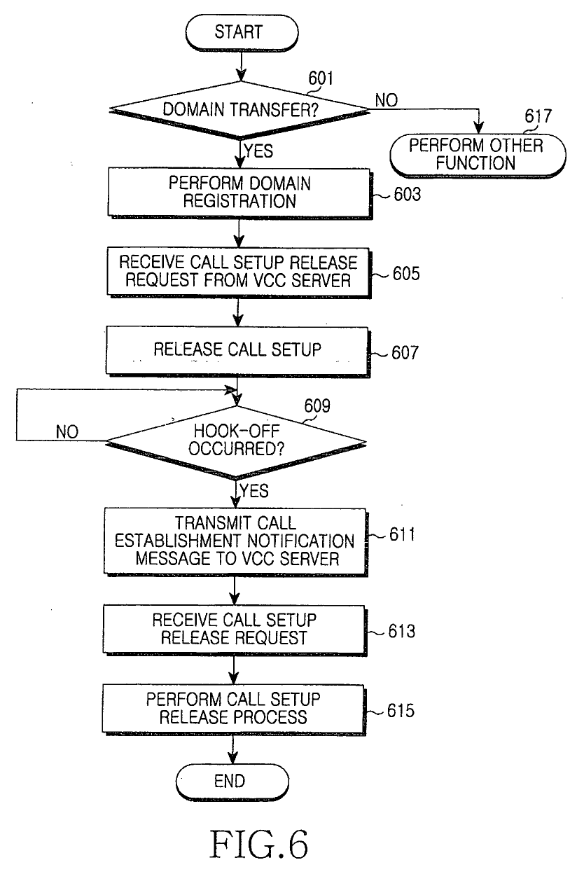

FIG. 6 is a flow diagram illustrating a process for performing a call connection for a domain transfer of the called portable terminal 240 in the mobile communication system according to another exemplary embodiment of the present invention.

Referring to FIG. 6, in step 601, the called portable terminal 240 determines whether a domain transfer occurs. According to an exemplary implementation, it is assumed that the called portable terminal 240 is ringing a phone bell according to a call setup request of the calling portable terminal 200.

If the domain transfer does not occur (in step 601), the call connection process proceeds to step 617. In step 617, the called portable terminal 240 performs other function (for example, a call setup for the current service network).

If the domain transfer occurs (in step 601), the call connection process proceeds to step 603. In step 603, the called portable terminal 240 performs domain registration and authentication for a domain to which the called portable terminal 240 transferred (hereinafter referred to as a destination domain).

In this case, the domain registration and authentication of the called portable terminal 240 is to register in the destination domain, which may be performed using a conventional domain transfer process.

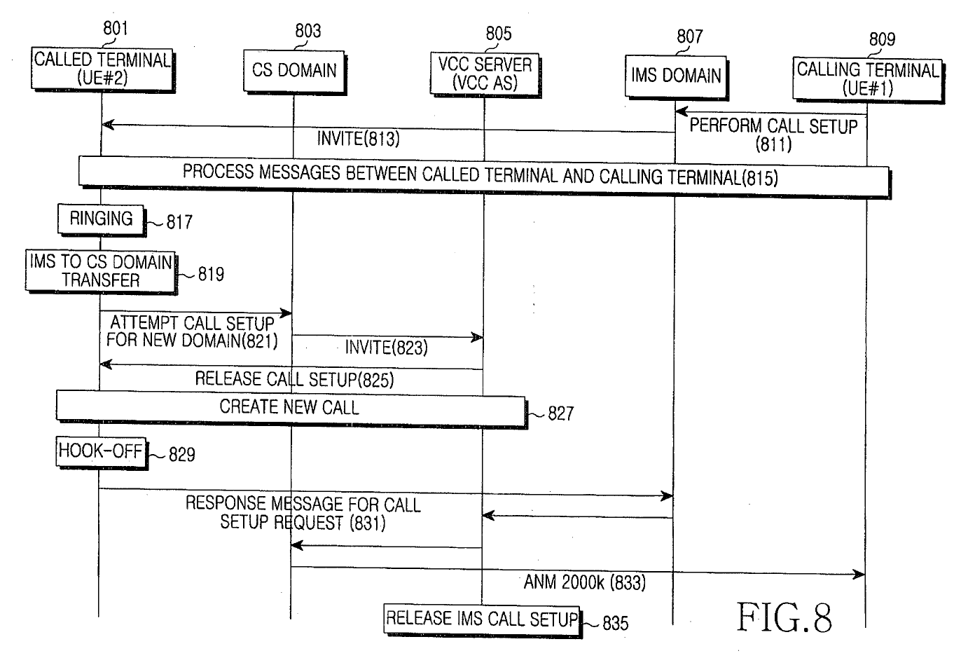

For example, the called portable terminal 240 performs registration and authentication for the destination domain, routes a prescribed service code and a VCC service E. 164 number to a Voice Mail Service Center (VMSC), and gets the VMSC to transmit the prescribed service code to the VCC server 230. These processes will be described later in detail with reference to FIG. 8.

Although the domain transfer process has been described by prescribing the service code and the VCC service E. 164 number between the portable terminal and the VCC server, it may be performed using the “3GPP2 X.P0042-001-0 9.2 Signaling Flow for Handoff: HRPD VoIP-to-1x Circuit-Switched Voice (Trigger Based) scheme”.

In step 605, the called portable terminal 240 receives a call setup release request from the VCC server 230. In step 607, the called portable terminal 240 performs a call setup release process.

According to an exemplary implementation, the call setup release process is a process for releasing the call setup performed after the domain transfer of the called portable terminal 240.

In step 609, the called portable terminal 240 determines whether a hook-off event occurs. If the hook-off event does not occur (in step 609), the called portable terminal 240 repeats step 609.

Alternatively, if the hook-off event occurs, the call connection process proceeds to step 611. In step 611, the called portable terminal 240 transmits a hook-off based call establishment notification message to the VCC server 230. Herein, the called portable terminal 230 may transmit the call establishment notification message through a mobile communication network prior to the domain transfer.

In step 613, the called portable terminal 240 receives a call setup release request from the VCC server 230.

In this case, the call setup release request is a request for releasing the call setup process performed before the domain transfer of the called portable terminal 240.

In step 615, the called portable terminal 240 releases the call setup with the VCC server 230. The call connection process is then ended.

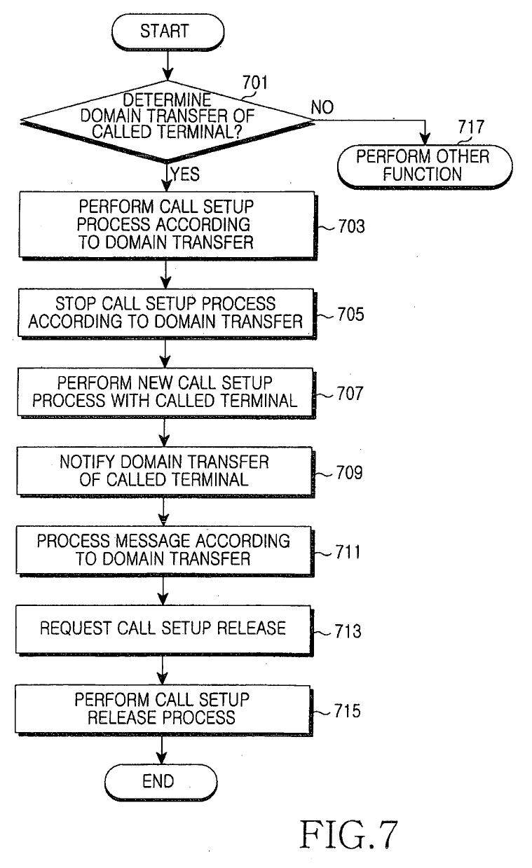

FIG. 7 is a flow diagram illustrating a process for performing a call connection at the VCC server 230 in the mobile communication system for a domain transfer of the called portable terminal 240 according to another exemplary embodiment of the present invention.

Referring to FIG. 7, in step 701, the VCC server 230 determines whether the called portable terminal 240 performs a domain transfer.

In this case, the domain transfer of the called portable terminal 240 may be determined through information about whether a call setup request message for the domain transfer of the called portable terminal 240 is received.

If the called portable terminal 240 does not perform the domain transfer (in step 710), the call connection process proceeds to step 717. In step 717, the VCC server 230 performs another function (for example, a standby mode).

Alternatively, if the called portable terminal 240 performs the domain transfer (in step 710), the call connection process proceeds to step 703. In step 703, the VCC server 230 receives a call setup request according to the domain transfer of the called portable terminal 240 to perform a call setup process with the called portable terminal 240.

In step 705, the VCC server 230 requests the called portable terminal 240 to stop the call setup process according to the domain transfer. In step 707, the VCC server 230 creates a new call with the called portable terminal 240.

According to an exemplary implementation, using a location information request message (LOCREQ) and a routing request message (ROUTREQ), the VCC server 230 detects a Temporary Local Direction Number (TLDN) indicating the registration location information of the called portable terminal 240. The VCC server 230 transmits an INVITE message carrying the detected TLDN to the CS network 220 in which the called portable terminal 240 is located.

In step 709, the VCC server 230 transmits a domain transfer notification message for the called portable terminal 240 to the calling portable terminal 200. In step 711, the VCC server 230 processes a message according to the domain transfer.

For example, step 711 includes receiving a response message for the domain transfer notification message from the calling portable terminal 200, and processing a call establishment notification message according to a hook-off event of the called portable terminal 240.

The VCC server 230, which has received the response message for the domain transfer notification message from the calling portable terminal 200, does not transmit the received response message to the called portable terminal 240.

Also, the VCC server 230, which has received the call establishment notification message from the called portable terminal 240, transmits a response message for the call setup request performed after the domain transfer of the called portable terminal 240 to the calling portable terminal 200.

In step 713, the VCC server 230 performs a call setup release request performed by the called portable terminal 240. In step 715, the VCC server 230 performs a call setup release process performed by the called portable terminal 240.

According to an exemplary implementation, the call setup release request is a request for releasing the call setup process performed before the domain transfer of the called portable terminal 240.

Thereafter, the call connection process is ended.

FIG. 8 is a flow diagram illustrating a process for performing a call connection in the mobile communication system for a domain transfer of the called portable terminal 240 according to another exemplary embodiment of the present invention.

Referring to FIG. 8, the mobile communication system includes a called portable terminal 801, a CS network 803, a VCC server 805, an IMS network 807, and a calling portable terminal 809.

First, the calling portable terminal 809 performs a call setup process 811 for performing a call connection with the called portable terminal 801 through the IMS network 807.

In this case, the call setup process may be performed by initially transmitting an INVITE message to the IMS network 807. The IMS network 807 transmits the received message to the VCC server 805, thereby performing an anchoring process of the calling portable terminal 809.

The anchoring process is a process for the VCC server 805 to store/manage user information and call information for the corresponding call request during a call setup process so that a portable terminal performing a domain transfer may maintain a stable call connection, and an anchoring process of the calling portable terminal 809 is also performed.

The mobile communication system then performs a message processing process 815 between the called portable terminal 801 and the calling portable terminal 809. The message processing process may be performed by transmitting an INVITE message to the called portable terminal 801 (in step 813).

According to an exemplary implementation, the message processing process 815 is a process that is performed from the time when the called portable terminal 801 rings a phone bell to the time when the calling portable terminal 809 receives a ring-back tone. In the message processing process 815, the mobile communication system processes an INVITE message, a 183 session progress message, an UPDATE message, and a 180 ringing message.

When the message processing process 815 is completed, the called portable terminal 801 rings a phone bell (in step 817).

When the called portable terminal 801 transfers from the IMS network 807 to the CS network 803 (in step 819), the called portable terminal 801 attempts a call setup process for the CS network 803 (in step 821).

The CS network 803 informs the VCC server 805 via an INVITE message that the calling portable terminal 809 is performing a call setup process for the CS network 803 after a domain transfer (in step 823).

The VCC server 805 then requests the called portable terminal 801 to stop the call setup process (in step 825), and creates a call for connection with the called portable terminal 801 (in step 827).

The call creation process of the VCC server 805 may include detecting a Temporary Local Direction Number (TLDN) indicating the registration location information of the called portable terminal 801 by using a location information request message (LOCREQ) and a routing request message (ROUTREQ), and transmitting an INVITE message carrying the detected TLDN to the CS network 803 in which the called portable terminal 801 is located.

When a hook-off event occurs in the called portable terminal 801 (in step 829), the called portable terminal 801 transmits a response message for a call setup request generated according to a domain transfer through the IMS network 807 to the VCC server 805 (in step 831).

Upon receipt of the response message from the VCC server 805, the called portable terminal 801 transmits a response message (ANM 200 OK) for a call setup request through the CS network 803 to the calling portable terminal 809 (in step 833).

The VCC server 805 then releases the call setup performed before the domain transfer of the called portable terminal 801 (in step 835).

As described above, when a domain transfer occurs during the call setup process of the portable terminal, an exemplary embodiment of the present invention performs a call setup process with the VCC server and the destination domain, thereby making it possible to maintain the call setup process during the domain transfer.

While the present invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A mobile communication system for maintaining a call setup for a domain transfer, the mobile communication system comprising:
a calling terminal for notifying, when performing a domain transfer during reception of a ring-back tone in a call setup process with a called terminal, the domain transfer to a voice call continuity (VCC) server, and for receiving a response message for a call setup request from the VCC server to perform a call connection with the called terminal; and
the VCC server for performing, when receiving a domain transfer notification message from the calling terminal, a call setup process with a domain to which the calling terminal transferred while maintaining the previous call setup process performed before the domain transfer, and for releasing the previous call setup process.

2. The mobile communication system of claim 1, further comprising the called terminal for notifying, when performing a domain transfer during a call setup process with the calling terminal, the domain transfer to the VCC server, and for receiving a response message for a call setup request from the VCC server to perform a call connection with the calling terminal.

3. The mobile communication system of claim 1, wherein when receiving the domain transfer notification message from the called terminal, the VCC server notifies the domain transfer of the called terminal to the calling terminal, receives a response message for the call setup request from the calling terminal, and transmits the received response message to the called terminal.

4. The mobile communication system of claim 3, wherein the VCC server receives an INVITE message from the terminal, which has performed the domain transfer, to detect the domain transfer, and notifies the domain transfer of the terminal to the terminal, which has not performed the domain transfer, by using an UPDATE message.

5. The mobile communication system of claim 4, wherein the domain transfer includes a domain transfer from a circuit switch (CS) network to an IP multimedia subsystem (IMS) network or from the IMS network to the CS network.

6. The mobile communication system of claim 1, wherein the VCC server receives a response message for a call setup request, which is performed before a domain transfer, from the terminal that does not perform the domain transfer, and transmits a response message for a call setup request performed according to the domain transfer to the terminal that has performed the domain transfer.

7. A method for maintaining a call setup for a domain transfer of a calling terminal in a mobile communication system, the method comprising:
performing a call setup process by the calling terminal to the destination domain to perform a call connection with a called terminal when a domain transfer to a destination domain occurs during reception of a ring-back tone according to a call setup process; and
performing a call setup process by a voice call continuity (VCC) server with the domain to which the calling terminal transferred while maintaining the previous call setup process performed before the domain transfer when detecting a domain transfer of the calling terminal, and for releasing the previous call setup process.

8. The method of claim 7, wherein the call setup process of the calling terminal comprises:
notifying the domain transfer of the calling terminal to the VCC server by transmitting a domain setup request for the destination domain during the previous call setup process when a domain transfer to a destination domain occurs during reception of a ring-back tone according to a call setup process;
receiving a response message for the call setup request from the VCC server; and
releasing the previous call setup process.

9. The method of claim 7, wherein the call setup process of the VCC server comprises:
notifying the domain transfer of the calling terminal to the called terminal through the previous domain in which the calling terminal is located before the domain transfer when receiving information indicating the domain transfer of the calling terminal;
receiving a response message for the call setup request performed before the domain transfer of the calling terminal from the called terminal;
transmitting a response message for the domain transfer to the calling terminal after receipt of the response message; and
releasing the previous call setup process of the calling terminal.

10. The method of claim 9, wherein the VCC server receives an INVITE message from the calling terminal, which has performed the domain transfer, to detect the domain transfer, and notifies the domain transfer of the calling terminal to the called terminal by using an UPDATE message.

11. The method of claim 10, wherein the domain transfer includes a domain transfer from a circuit switch (CS) network to an IP multimedia subsystem (IMS) network or from the IMS network to the CS network.

12. A method for maintaining a call setup for a domain transfer of a called terminal in a mobile communication system, the method comprising:
notifying by the called terminal, when a domain transfer to a destination domain occurs while a phone bell is ringing according to a call setup process, the domain transfer to a calling terminal; and
stopping by a voice call continuity (VCC) server, when detecting a domain transfer of the called terminal, the call setup process performed according to the domain transfer of the called terminal, and notifying the domain transfer of the called terminal to the calling terminal.

13. The method of claim 12, wherein the call setup process of the called terminal comprises:
receiving a response message for the call setup request from the VCC server after notification of the domain transfer of the called terminal; and
stopping the previous call setup process performed with the VCC server.

14. The method of claim 12, wherein the notifying of the domain transfer of the called terminal comprises:
performing a call setup process for a destination domain when a domain transfer to the destination domain occurs while a phone bell is ringing according to a call setup process;
stopping the call setup process according to the request of the VCC server; and
creating a call for notification of the domain transfer according to the request of the VCC server to notify the domain transfer of the called terminal.

15. The method of claim 12, wherein the call setup process of the VCC server comprises:
stopping the call setup process of the called terminal when receiving information indicating the domain transfer of the called terminal;
notifying the domain transfer of the called terminal to the calling terminal by using a call for notification of the domain transfer of the called terminal;
receiving a response message for the call setup request performed before the domain transfer of the called terminal from the calling terminal;
transmitting a response message for the domain transfer to the called terminal after receipt of the response message; and
releasing the previous call setup process of the calling terminal.

16. The method of claim 15, wherein the VCC server receives an INVITE message from the called terminal, which has performed the domain transfer, to detect the domain transfer, and notifies the domain transfer of the called terminal to the calling terminal by using an UPDATE message.

17. The method of claim 16, wherein the domain transfer includes a domain transfer from a circuit switch (CS) network to an IP multimedia subsystem (IMS) network or from the IMS network to the CS network.
